(19) United States
(12) Patent Application Publication
(10) Pub. No.: US 2007/0258001 A1
(43) Pub. Date: Nov. 8, 2007

(54) Method for Producing High Signal to Noise Spectral Measurements in Optical Dectector Arrays

(76) Inventors: Alexei Stanco, Thebarton (AU); Aizengendler Mark, West Lakes Shores (AU)

Correspondence Address: Francis Law Group, 1942 Embarcadero, Oakland, CA, 94606, US

(21) Appl. No.: 10/587,579

(22) PCT Filed: Jan. 31, 2005
(86) PCT No.: PCT/AU05/00118

§ 371 Date: Apr. 9, 2007

(30) Foreign Application Priority Data
Jan. 30, 2004 (AU) 2004900428

(51) Int. Cl. H04N 5/335

(52) U.S. Cl. 348/311; 348/E05.091

(57) ABSTRACT

The present invention relates to a method and apparatus for producing high signal to noise spectral measurements in optical detector arrays and in particular to uncooled linear CCD arrays. This is accomplished by providing a detector and a database of dark signal readings unique to that detector that is generally created at the time of manufacture and that can then be used to provide a value for the dark signal inherent to that detector that can be used to correct the measured signal. The detector also includes a means to measure its temperature so that the appropriate dark signal value can be subtracted from the measured signal. This is because the dark signal is a function of both the temperature and the exposure time.

### BACKGROUND OF THE INVENTION

Charge coupled devices (CCD's) are used in a variety of applications and convert photons that hit each device into a charge, the charge of each CCD being measured typically at the corner of the device. An analog to digital converter then converts the accumulated charge into a digital signal.

CCD's measure light signal in the UV to NIR region of the optical spectrum and are widely used to measure fringes of light or the spectrum of light dispersed by a spectrograph.

To achieve high signal-to-noise ratio measurements the detectors typically have to either be cooled to reduce their inherent dark signal or alternately have their dark signal subtracted from the measured signal. Thermoelectric Peltier devices or liquid nitrogen Dewars typically are used for cooling the detectors. Both of these are however expensive and the Peltier devices have a somewhat limited cooling ability dependant in part on the ambient temperature.

Subtraction of the dark signal at room temperature is also problematic because the dark signal of each detector varies with its temperature. For that reason the standard technique to subtract the dark signal is to measure it immediately before taking the signal measurement and then subtract it from the measured signal over the same exposure time. This of course assumes that the detector does not change its temperature before the signal is measured. Dark signal contains dark noise that is a function of dark signal (square root). After subtracting the dark signal from light signal noise will contribute the overall signal which results in decreasing signal to noise ratio. Therefore to avoid this effect the dark measurement has to be taken several times and averaged. In this case the dark noise would be reduced but the total time of measurement increased.

To be able to measure the dark signal one needs to isolate the detector from any light. Typically a shutter or other mechanical block is used to obscure the detector from light before making the measurement. Not only do some systems simply do not have suitable shutter mechanisms but measuring the dark signal also takes time slowing the whole measurement process.

Thus current techniques for achieving high signal to noise measurements rely on the need for expensive cooled detector systems or alternatively complex, expensive and time consuming shutter systems.

It is an object of the present invention to provide for a method and apparatus for high signal-to-noise measurements of CCD's that overcome at least some of the abovementioned problems or provide the public with a useful alternative.

The present invention relates to a method and apparatus for producing high signal to noise spectral measurements in optical detector arrays and in particular to uncooled linear CCD arrays. This is accomplished by providing a detector and a database of dark signal readings unique to that detector that is generally created at the time of manufacture and that can then be used to provide a value for the dark signal inherent to that detector that can be used to correct the measured signal. The detector also includes a means to measure its temperature so that the appropriate dark signal value can be subtracted from the measured signal. This is because the dark signal is a function of both the temperature and the exposure time.

### SUMMARY OF THE INVENTION

Therefore in one form of the invention there is proposed an apparatus for the measurement of a spectrum said apparatus including;

a CCD array including a plurality of individual detectors, each said detector producing a signal corresponding to the amount of light measured by said detector;

a database of the dark signal measured by each said detector when no light has fallen on said detector; and

a signal correction device that reduces the signal measured by each said detector by the dark signal to produce a corrected signal for each said detector.

Preferably said apparatus includes a temperature-measuring device adapted to measure the temperature of said array, said database including the dark signal for each detector measured at several different temperatures. Thus removing the dark signal that was measured according to the temperature of the array can compensate for the signal of the CCD array.

Preferably said apparatus includes a time calculating device said database including the dark signal for each detector measured at several different temperatures. Thus removing the dark signal that was measured over the same temperature as the current measurement can compensate for the signal of the CCD array.

In a further form of the invention there is proposed a method of correcting the signal of each detector in a CCD array measuring a light distribution across the array said method including the steps of:

measuring the dark signal of each detector when no light is falling onto said detector and storing said dark signal in a database;

measuring the signal of each detector with light falling onto said array; and

removing the dark signal for each detector from the measured light signal to provide a corrected spectrum.

In preference said method further includes the steps of:

(a) measuring the dark signal of each detector at a first temperature;

(b) storing the dark signal for each detector for said first temperature in a database;

(c) varying the temperature of said array to a second temperature; repeating steps (a) to (c) for a number of different temperatures.

In a still further form of the invention there is proposed a method of using a CCD array of the type including a database as constructed by the method above, said method including the steps of:

measuring the temperature of the array when measuring a light distribution;

recalling the dark signal for each detector stored in said database representative of said measured temperature; and

subtracting the recalled dark signal from the database for each detector from the measured signal of each detector.

In preference said method further includes the steps of taking the dark signal measurement over a pre-determined period.

In preference said database is provided in a memory means located on said CCD array.

In preference said dark signal stored in said database is an average of a plurality of dark signals measured over said time and temperature. This improves the accuracy of the dark signal measurement.

Preferably said database is provided on a CD or other storage media.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention In the drawings,

FIG. 1 is a schematic diagram illustrating the known technique of measuring a spectrum using a CCD array;

FIG. 2 is a schematic diagram illustrating the technique of measuring the spectrum using a CCD array according to the present invention;

FIG. 3(a) is a typical spectrum of a signal measured at 16 degrees Centigrade and including the dark signal and spectra, measured over exposures of 1 second, 2 seconds, 5 seconds and 10 seconds;

FIG. 3(b) is the corrected spectra of FIG. 3(a) with the dark signal removed using the method as per the present invention;

FIG. 4(a) is a typical spectrum of a signal measured at 23 degrees Centigrade and including the dark signal and spectra, measured over exposures of 1 second, 2 seconds, 5 seconds and 10 seconds;

FIG. 4(b) is the corrected spectra of FIG. 4(a) with the dark signal removed;

FIG. 5(a) is a typical spectra of a signal measured at 30 degrees Centigrade and including the dark signal and a spectra, measured over exposures of 1 second, 2 seconds, 5 seconds and 10 seconds; and

FIG. 5(b) is the corrected spectra of FIG. 5(a) with the dark signal removed.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

CCD arrays are well known and typically include hundreds or thousands of individual detectors in a one or two-dimensional array. When used to measure spectra only a one-dimensional array is required. The rest of the description hereon in refers to a one-dimensional array. It is however to be understood by the reader that the invention could equally well apply to two-dimensional arrays, for example, for image formation or where vertical binning is used to form a line spectrum.

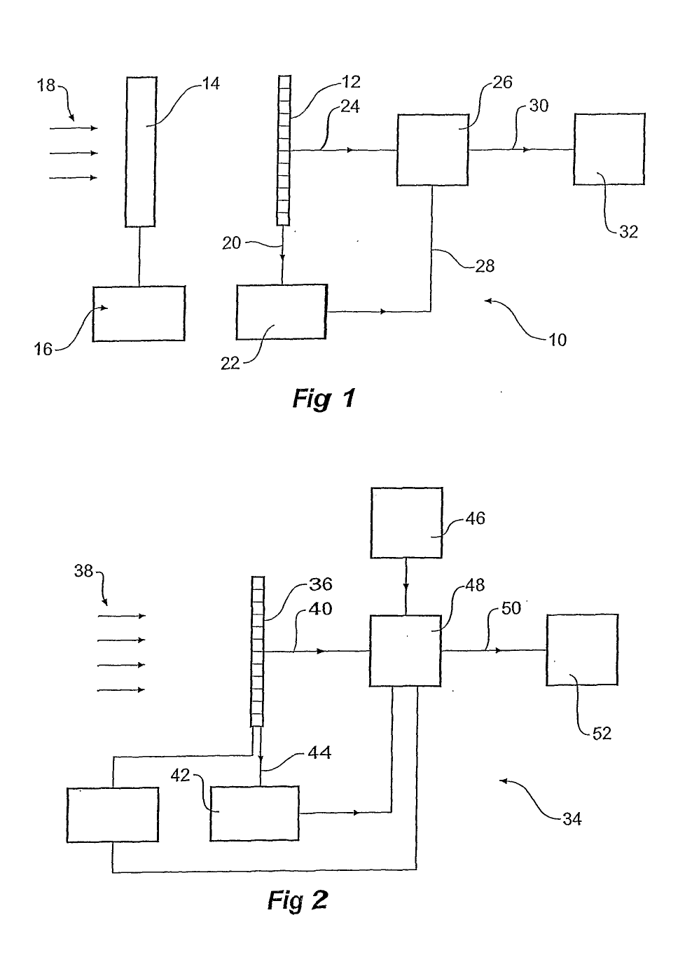

The current technique for measuring the spectrum using a CCD array includes a system as represented in FIG. 1 wherein the apparatus 10 includes a CCD array 12 in front of which is placed a shutter 14 controlled by a motor or solenoid 16. When measuring a spectrum 18 the shutter is closed so that no light reaches the CCD array 12. The array then measures a signal 20 for each detector, known as the dark signal, that are stored in memory 22. The shutter 14 is then opened and the signal 24 of the spectrum measured by the CCD array including a dark signal component is fed to a processing unit 26 that subtracts the dark signal 28 to produce a corrected signal 30 that can then be displayed or stored in unit 32. Without subtraction of the dark signal the measurement of the spectrum will show artifacts of the dark signal.

We have discovered through careful measurements of the dark signal characteristics of CCDs over a range of temperatures and exposure times that the dark signal characteristics are reproducible and stable over a long period of time. Therefore by measuring the dark signal of a specific detector over the full range of normal operating temperatures, say 15 to 30 degrees Centigrade, and for exposure times up to 10 seconds, and storing this data in a database it can be easily used afterwards for later subtraction from the measured signal.

Thus, each CCD array is cycled through a range of temperatures and exposure times constructing a table of data that then becomes unique to that array. The table includes the dark noise characteristics for each detector over a range of temperatures and exposure times. In an array say of some 2000 detectors, assuming that there is a measurement of dark noise for every degree Centigrade between 16 and 30 degrees and assuming that the exposure times are some 1 seconds, 2 seconds, 5 seconds and 10 seconds there is a total of 2000×15 ×4 or some 120,000 data values.

These data values can either be stored on a memory means on the array, easily achievable since devices with large memory capacities are now available. Alternately, the data can be stored on a storage medium, such as a CD, that is then used by appropriate software when calculating the measured spectra. Such a CD may indeed contain the correction spectra for multiple detector arrays. By labeling each correction spectra and detector array by a unique identification means one can easily using well-known sophisticated computer systems ensure that the appropriate correction spectra is used on the appropriate detector array.

When the end user uses the particular array they only need to ensure that the current temperature of the arrays is known. This can be measured by a thermocouple attached to the CCD array, or via any thermal detector internal/on-board to the CCD chip. Of course a temperature-varying characteristic of the CCD and on-chip electronics may equally well be employed and it is not intended to limit the invention to a thermocouple or thermal detector.

Thus as illustrated in FIG. 2 the apparatus 34 according to the present invention includes a CCD array 36 that measures a spectrum 38 providing signal 40 including the individual measured dark signal response of each detector. The CCD includes a thermocouple 42 or the like to measure the temperature 44 of the array. A database 46 includes the dark signal characteristics of each of the CCD detectors over a range of temperatures and times.

The signal 40 and temperature 44 is fed to a processing or computing unit 48 that then recalls the appropriate dark signal characteristics of the CCD array for that temperature (or closest to it). The processing unit 48 then subtracts the dark signal from the measured one to provide a corrected signal 50 of the spectrum that can then be further analysed or displayed on display 52.

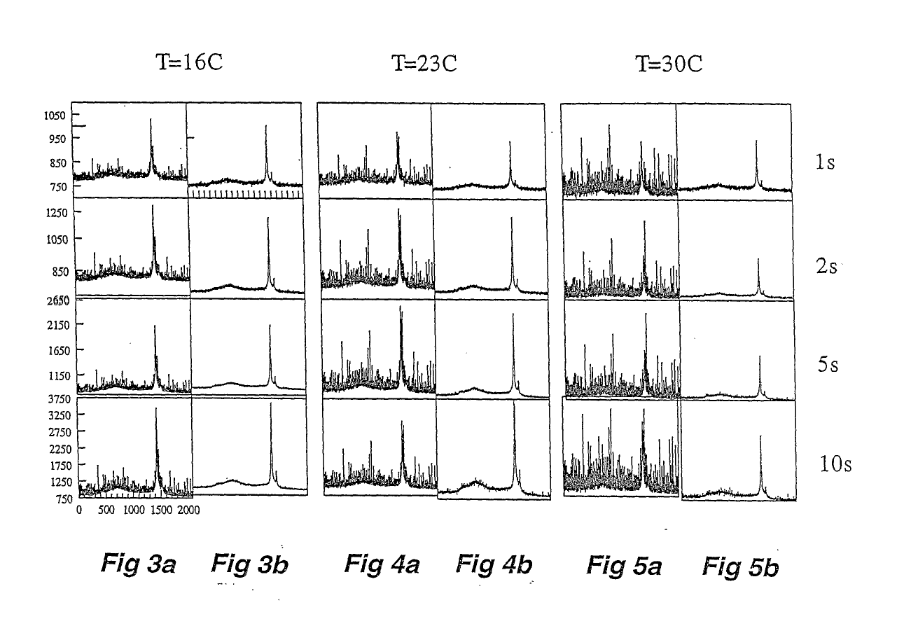

Illustrated in FIG. 3(a) are the measured spectra of a weak line at a temperature of 16 degrees over four exposure times, namely 1 second, 2 seconds, 5 seconds and 10 seconds. Illustrated in FIG. 3(b) is the spectrum that has been corrected by taking out the dark signal. The x-scale is the actual individual detectors, whilst the y-scale is the actual number of counts by each detector. One can easily see that the quality of the corrected spectra is indeed high and that the subtraction of the dark signal from the measured data values improves the signal-to-noise ratio by a number of factors, the main spectral line being easy to spot even in the raw signal.

However, the advantage of the present invention is clearly illustrated as the operating temperature of the array increases to 23 degrees (FIGS. 4(a) and 4(b)) and then to 30 degrees (FIGS. 5(a) and 5(b)). When the temperature of the array is some 30 degrees the measured spectrum across all exposure times has a significant amount of noise, making it difficult for the casual observer to discern between a measured line and noise. Yet the correction of the spectrum by subtraction of the dark signal results in a spectrum whose signal-to noise ratio is not that fundamentally different to the corrected spectrum measured at a much lower temperature.

Thus the reader will now understand that by knowing the planned exposure time, a parameter set by a user on every measurement, the temperature of the detector, and by having access to the database of dark signal characteristics, one can accurately calculate the dark signal. This can then be subtracted from the signal measurement to create an optimal high signal-to-noise measurement without the need to measure the dark signal again. This is a clear departure from current techniques where the dark signal is measured in-situ just before the real measurement is taken.

The advent of large scale, low cost memory, has enabled the storage of such a database practical for linear CCD detectors in particular, and the high speed of current PCs enables such dark signal corrections to be calculated in software with minimal delay.

Acquisition of the database at the time of manufacture of the detector head, or on subsequent calibration, is however a long process that could take hours per detector as the detector has to be cycled through the full temperature range of interest. Ideally the data collected also may have to be corrected for Cosmic ray induced artifacts during the collection process that could otherwise corrupt the dark signal measurements.

By providing such a database of a detector's dark signal characteristics, together with a means to accurately measure the temperature of the detector elements, optimal signal-to-noise measurements can be made with an un-cooled detector. The need to cool the detector to eliminate the dark signal or measure and subtract the dark signal at the time of measurement is eliminated saving both cost and time for cooling down the detector.

In most cases however it would be unreasonable to have a dark signal measurement for each pixel in a CCD array measured both over time and over different temperatures. We have discovered that the temporal behaviour of the dark signal is generally linear and thus a measurement over one period is sufficient to be representative of the dark signal over different times. The same is not true of temperature, the response of the dark signal not being linear. Thus we measure the dark signal over a number of temperature levels, typically one Centigrade apart, and if the temperature of the array falls in between two values linearly interpolate across that.

Typically the dark signal is measured over a period of 1 second and across a temperature of some 15 to 30 degrees Centigrade in one-degree intervals. Thus for each pixel in a CCD array there is a table of some 16 values corresponding to the dark signal measured over one second over 16 temperature levels. When the pixel is used to measure light falling over it for a set period of time that dark signal is simply multiplied by the time factor chosen at the temperature of the array. If the temperature of the array is at a value between two measured levels, its value is linearly interpolated. Although this may not be a perfect approximation it has been found to be quite satisfactory.

A further problem that may occur in these types of CCD arrays is that some pixels may contain defects that show up at different temperatures. Those pixels can be identified by the rapid and unpredictable change in dark signal. To identify and compensate for these pixels at those temperatures one excludes them from the measurement and rather provides the measurement from adjacent non-defect pixels. Of course one has to take into account the case of two-dimensional arrays or outer edge pixels. However the skilled addressee should have no difficulty in using appropriate algorithms to provide a solution.

In constructing the dark signal table one preferably averages over a number of measurements at each temperature. This has the effect of reducing the noise in each pixel equal to the square root of the number of measurements. Thus for example if the same measurement has been taken 100 times, the noise contribution has been reduced by a factor of 10 with respect to the signal. This can be extremely important where the signal level is quite low and comparable to the dark signal. By having a low noise one then has a more accurate measurement of the dark signal.

It is envisioned that the invention can be used with all types of linear optical detector arrays of any material and sensitive in the VUV to IR be it CMOS, InGaAs, Si-Diode or other such detectors matched to a spectral region which proves to have a stable dark signal characteristic over time.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

1. An apparatus for the measurement of a spectrum, comprising;
a CCD array including a plurality of individual detectors, each of said plurality of detectors producing a signal dependent ion the amount of light measured by said detectors;
a database including a dark signal measured by each of said plurality of said detectors when no light has fallen on said detectors;
a temperature-measuring device adapted to measure the temperature of said array, said database including said dark signal for each of said plurality of detectors measured at several different temperatures;
a time calculating device adapted to measure exposure time, said database including said dark signal for each of said plurality of detectors measured at several different exposure times; and
a signal correction device that reduces the signal measured by each of said plurality of detectors by the dark signal to produce a corrected signal for said detectors;

2. A method of correcting the signal of each detector in a CCD array measuring a light distribution across the array, said method comprising the steps of:
measuring a dark signal of each detector when no light is falling onto said detector and storing said dark signal in a database;
measuring a light signal of each detector with light falling onto said array; and
removing said dark signal for each detector from the measured light signal to provide a corrected spectrum.

3. The method of correcting the signal of each detector in a CCD array as in claim 2, wherein said method further includes the steps of:
(a) measuring said dark signal of each detector at a first temperature;
(b) storing said dark signal for each detector for said first temperature in a database;
(c) varying the temperature of said array to a second temperature; and
(d) repeating steps (a) to (c) for a plurality of different temperatures.

4. The method of correcting the signal of each detector in a CCD array as in claim 3, wherein said method further includes the steps of;
measuring said temperature of the array when measuring a light distribution;
recalling said dark signal for each detector stored in said database representative of said measured temperature; and
subtracting said recalled dark signal from said database for each detector from said measured signal of each detector.

5. The method of correcting the signal of each detector in a CCD array as in claim 2, wherein said method further include the step of taking said dark signal measurement over a pre-determined period of time.

6. The method of correcting the signal of each detector in a CCD array as in claim 3, wherein said database is provided in a memory means located on said CCD array.

7. The method of correcting the signal of each detector in a CCD array as in claim 3, wherein said dark signal stored in said database is an average of a plurality of dark signals measured over said time and temperature.

8. The method of correcting the signal of each detector in a CCD array as in claim 3, wherein said database is provided on a CD.

9. (canceled)
